(19) United States
(12) Patent Application Publication
(10) Pub. No.: US 2012/0073460 A1
(43) Pub. Date: Mar. 29, 2012

(54) VARIABLE CUTOFF PRINTING PRESS AND METHOD FOR DOUBLE PRINTING

(75) Inventors: Glenn Alan Guaraldi, Kingston, NH (US); Mehmet Oktay Kaya, Exeter, NH (US)

(73) Assignee: Goss International Americas, Inc., Dover, NH (US)

(21) Appl. No.: 12/893,562

(22) Filed: Sep. 29, 2010

(51) Int. Cl. B41F 7/02

(52) U.S. Cl. 101/217

(57) ABSTRACT

A variable cutoff printing press is provided. The variable cutoff printing press includes a first cylinder printing on a web at a first longitudinal portion of the web and a second longitudinal portion of the web at the same time, the second longitudinal portion being downstream of the first longitudinal portion at least a distance equal to an effective circumference of the first cylinder. The variable cutoff printing press also includes a second cylinder forming at least one nip with the first cylinder, the first and second longitudinal portions of the web passing through the at least one nip. A method of variable cutoff printing is also provided.

The present invention relates generally to printing presses and more specifically to a variable cutoff printing press and method of printing a web in two passes through a printing unit.

### BACKGROUND OF INVENTION

Variable cutoff printing presses have been developed to allow a printing press to print different print jobs producing printed products of different cutoff lengths. For example, a first print job of a first cutoff length may require printing repeating images of one length on a web and then a second print job of a second cutoff length subsequent to the first print job may require printing images of another longer length on the web. In order to print both the first and second print jobs with a single printing press, circumferences of plate and blanket cylinders are sometimes varied. Printing plates used for the first printing job are removed from respective plate cylinders and replaced with printing plates having a longer cutoff length. Printing blankets are also removed from respective blanket cylinders and replaced, such that the printing blankets have a surface length or cutoff length equal to the cutoff length of the corresponding printing plate. Printing plates and printing blankets of different sizes may be accommodated on a single printing press by changing plate and blanket sleeves supporting the plates and blankets to vary the circumferences of the plate and blanket cylinder, by changing the entire bodies of the plate and blanket cylinders to vary the circumferences of the plate and blanket cylinder or by changing cartridges including the plate and blanket cylinders to vary the circumferences of the plate and blanket cylinder.

FIG. 1 shows a printing unit 200 of one conventional variable cutoff printing press that includes an ink and dampening fluid train 202 providing ink and dampening fluid to a plate cylinder 204. Plate cylinder 204 includes a printing plate 204a on the surface thereof imaged with an image for a print job. The image on the printing plate has a length corresponding to the cutoff length of the printing plate (which corresponds to substantially an entire circumference of plate cylinder 204) and a width corresponding to the printing width of the printing plate. During each revolution of plate cylinder 204, plate cylinder 204 transfers an inked image to a blanket 206a on the surface of a blanket cylinder 206, which, during each revolution, prints one image on a moving web 220 at a nip 222 formed with an impression cylinder 208.

Cylinders 204, 206, 208, rollers of train 202 and web 210 have the same uniform surface velocity and cylinders 204, 206 have the same circumferential length. Cylinders 204, 206 may include cylindrical bodies with plates 204a and blankets 206a directly mounted thereon or include mandrels with sleeves mounted thereon for mounting plates 204a and blankets 206a thereto. In order to change the cutoff length of cylinders 204, 206, plate 204a and blanket 206a are removed and either the entire bodies of cylinders 204, 206 are removed from printing unit 200 and replaced with bodies having larger or smaller circumferences or sleeves are removed from cylinders 204, 206 and replaced with sleeves having larger or smaller outer circumferences. During a cutoff change, an axis of plate cylinder 204 remains in the same position and positions of rollers of train 202, blanket cylinder 206 and impression cylinder 208 are readjusted according to the new diameters of the replacement bodies or sleeves.

### SUMMARY OF THE INVENTION

A variable cutoff printing press is provided including a first cylinder printing on a web at a first longitudinal portion of the web and a second longitudinal portion of the web at the same time, the second longitudinal portion being downstream of the first longitudinal portion at least a distance equal to an effective circumference of the first cylinder, and a second cylinder forming at least one nip with the first cylinder, the first and second longitudinal portions of the web passing through the at least one nip.

A variable cutoff printing press is provided including a blanket cylinder printing on a web and including a first blanket section and a second blanket section side-by-side, an additional cylinder forming at least one nip with the first cylinder, the web being printed by the first blanket section in a first pass of the web through the at least one nip, the web being printed by the second blanket section in a second pass of the web through the at least one nip.

A variable cutoff printing press is provided including a first removable blanket section rotating about a first axis, and a second removable blanket section rotating about the first axis, the first blanket section printing a first longitudinal section of a web as the second blanket section prints a second longitudinal section of the web previously printed by the first blanket section.

A method of printing a web is provided including printing a first image on a web with a first axial section of a blanket cylinder, guiding the web around a plurality of rollers, and printing a second image on the web with a second axial section of the blanket cylinder adjacent to the first image.

A method of variable cutoff printing is provided including printing a first print job by printing a first web twice with two different axial sections of a first blanket having a first cutoff length, replacing the first blanket with a second blanket having a second cutoff length different from the first cutoff length, and printing a second print job by printing a second web twice with two different axial sections of the second blanket.

A variable cutoff printing press is also provided that includes a first printing unit including a first plate cylinder and a first blanket cylinder, the first plate cylinder transferring side-by-side images to the first blanket cylinder, the first blanket cylinder printing one of the images on a first longitudinal portion of a web and another of the images on a second longitudinal portion of the web, a second printing unit downstream of the first printing unit, the second printing unit including a second plate cylinder and a second blanket cylinder, the second plate cylinder transferring side-by-side images to the second blanket cylinder, the second blanket cylinder printing one of the images on the first longitudinal portion of the web and another of the images on the second longitudinal portion of the web, a third printing unit downstream of the second printing unit, the third printing unit including a third plate cylinder and a third blanket cylinder, the third plate cylinder transferring side-by-side images to the third blanket cylinder, the third blanket cylinder printing one of the images on the first longitudinal portion of the web and another of the images on the second longitudinal portion of the web, and a fourth printing unit downstream of the third printing unit, the fourth printing unit including a fourth plate cylinder and a fourth blanket cylinder, the fourth plate cylinder transferring side-by-side images to the fourth blanket cylinder, the fourth blanket cylinder printing one of the images on the first longitudinal portion of the web and another of the images on the second longitudinal portion of the web.

### BRIEF DESCRIPTION OF THE DRAWINGS

The present invention is described below by reference to the following drawings, in which:

FIG. 1 shows a printing unit of one conventional variable cutoff printing press;

FIG. 2 shows a variable cutoff printing unit according to an embodiment of the present invention printing on a web;

FIGS. 3 to 12 shows sequential perspective views illustrating one revolution of a blanket cylinder of the printing unit shown in FIG. 2;

FIG. 13 shows a perspective view of the printing unit shown in FIGS. 2 to 12 along with rollers for redirecting the web between a first pass and a second pass through the printing unit;

FIG. 14 shows a graph illustrating an exemplary embodiment of how the velocity of the blanket cylinder shown in FIGS. 2 to 13 may be varied during each revolution to print images in the manner described in FIGS. 3 to 12;

FIG. 15 shows a graph corresponding to the exemplary embodiment shown in FIG. 14 illustrating a relationship between angular master steps of the virtual master signal and master time steps of a plate cylinder, the blanket cylinder and a master driver of the printing unit shown in FIGS. 3 to 12;

FIGS. 16 and 17 show perspective views of a variable cutoff four color printing press according to an embodiment of the present invention;

FIG. 18 schematically shows printing units of the printing press shown in FIGS. 16 and 17 being are controlled using virtual master software.

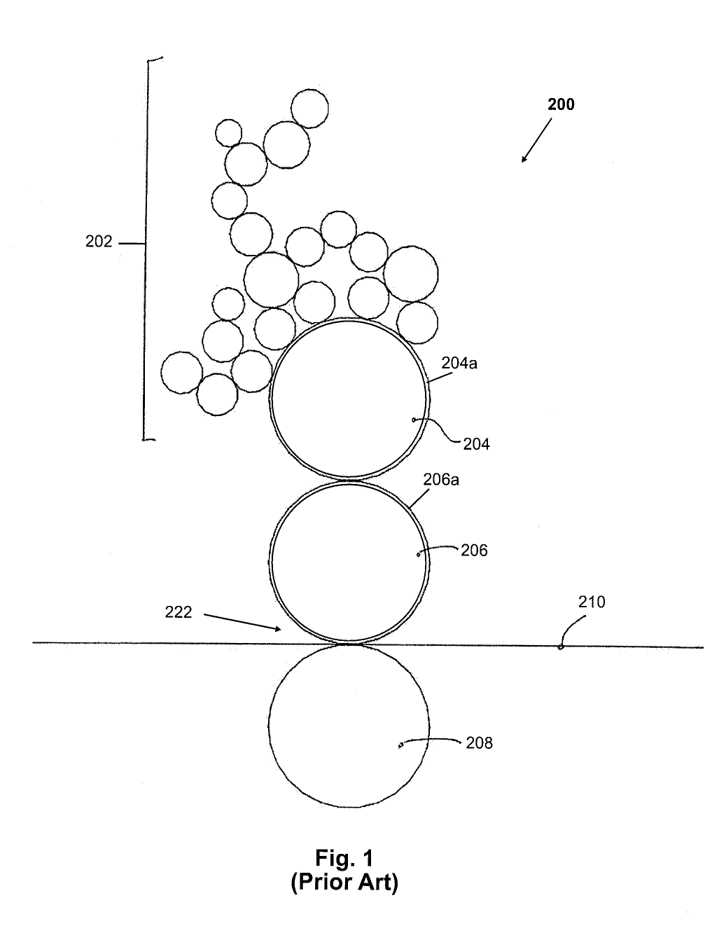

### DETAILED DESCRIPTION

The embodiments described below may advantageously allow cutoff changes without readjusting positions of ink and dampener rollers, blanket cylinders and impression cylinders.

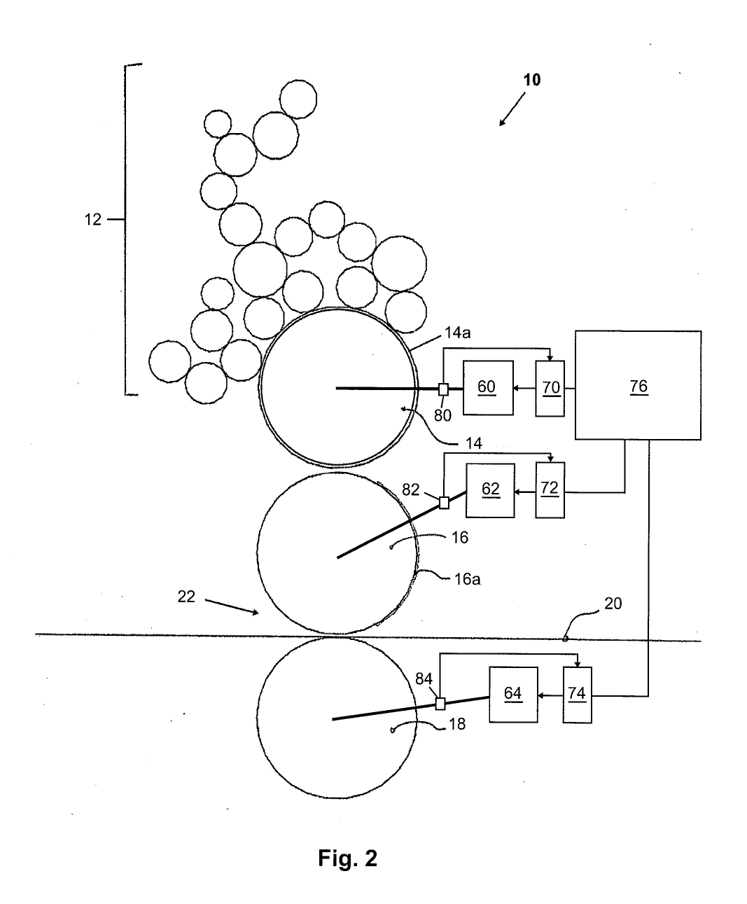

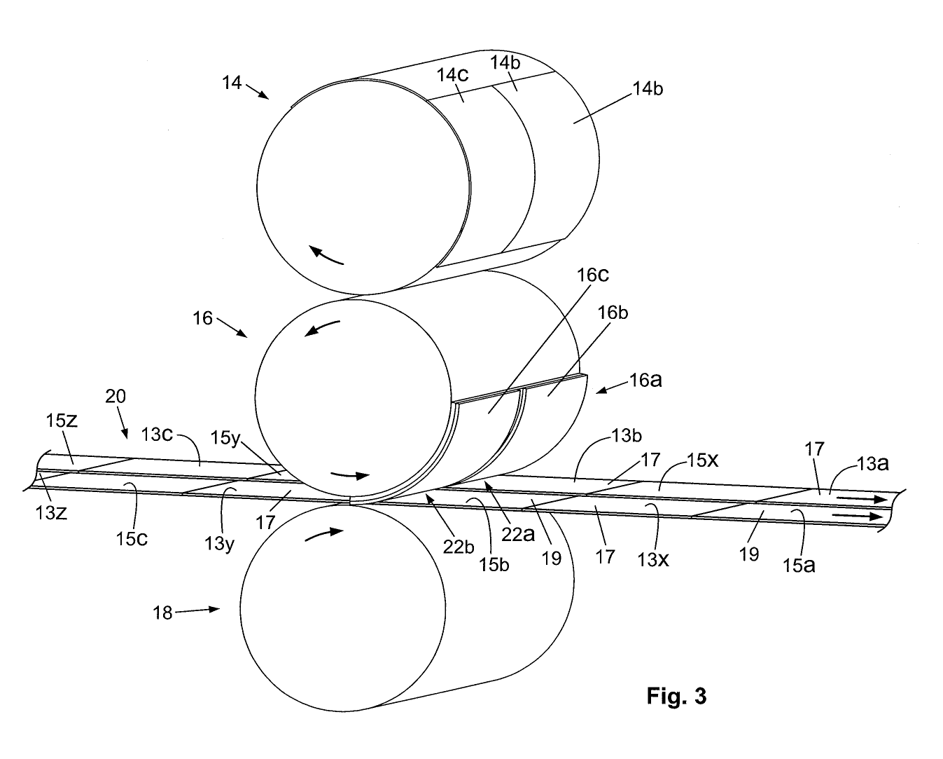

FIG. 2 shows a variable cutoff printing unit 10 according to one preferred embodiment of the present invention printing on a web 20. Printing unit 10 includes an ink and dampening fluid train 12 with rollers that provide ink and dampening fluid to a plate cylinder 14. Plate cylinder 14 includes a printing plate 14a on the surface thereof imaged with two image sections 14b, 14c (FIGS. 3 to 12) that are axially side-by-side on printing plate 14a. Image sections 14b, 14c on the printing plate both have a length defining a cutoff length of printing plate 14a. In this preferred embodiment, the cutoff length of printing plate 14a is less than a circumferential length of plate cylinder 14. As shown in FIG. 3, each image section 14b, 14c defines one half of a printing width of printing plate 14a and image sections 14b, 14c are imaged with identical images. Plate cylinder 14 and printing plate 14a each have a width that is at least twice the width of web 20.

During each revolution of plate cylinder 14, plate cylinder 14 transfers the two side-by-side images on printing plate 14a to a blanket 16a on the surface of a blanket cylinder 16. Blanket cylinder 16, during each revolution, at a nip 22 formed between blanket cylinder 16 and an impression cylinder 18, prints one image on an unprinted portion of web 20 passing through nip 22 for a first time (i.e., a first pass) and prints the other image on a portion of web 20 that is passing through nip 22 for a second time (i.e., a second pass). This two pass printing process of printing unit 10 is described in further detail with respect to FIGS. 3 to 13.

Plate cylinder 14, blanket cylinder 16 and impression cylinder 18 are driven by respective motors 60, 62, 64, which in one preferred embodiment are servomotors, controlled by respective controllers 70, 72, 74. Motors 60, 62, 64 are preferably receiving feedback of the respective angular positions of respective cylinders 14, 16, 18 from respective encoders or resolvers 80, 82, 84 to ensure cylinders 14, 16, 18 are in the desired angular position and traveling at the desired velocity. In the preferred embodiment shown in FIG. 2, an additional controller 76 is provided. Controller 76 includes virtual master software which transmits a virtual master signal to controllers 70, 72, 74 to appropriately synchronize cylinders 14, 16, 18 so blanket 16a contacts the appropriate portion of plate 14a at the appropriate velocity and blanket 16a contacts the appropriate portion of web 20 at the appropriate velocity. The virtual master software is programmable to simulate 360 angular steps about a virtual axis based on a specified time. Each angular step includes two or more time steps that provide increased precision and allow controller 72 increased control for adjusting motor 62 to accurately control blanket 16a to receive and print images. Time steps of motors 60, 62, 64 may then be compared to the virtual master time steps and be adjusted accordingly. In the embodiment shown in FIG. 2, the virtual master software is included in controller 76. Upon receiving feedback from encoder or resolver 82, controller 72 compares the actual position of cylinders 16 as determined by encoder or resolver 82 with the desired position of cylinder 16, which is determined based on the virtual master signal, and accelerates or decelerates cylinder 16 via motor 62 if necessary to ensure that blanket 16a is in the proper position when contacting web 20 or plate 14a. In another preferred embodiment, individual controllers 70, 72, 74 are not provided for each cylinder 14, 16, 18 and encoders 80, 82, 84 provide feedback directly to controller 76, which controls motors 60, 62, 64 based on the feedback and the virtual master signal.

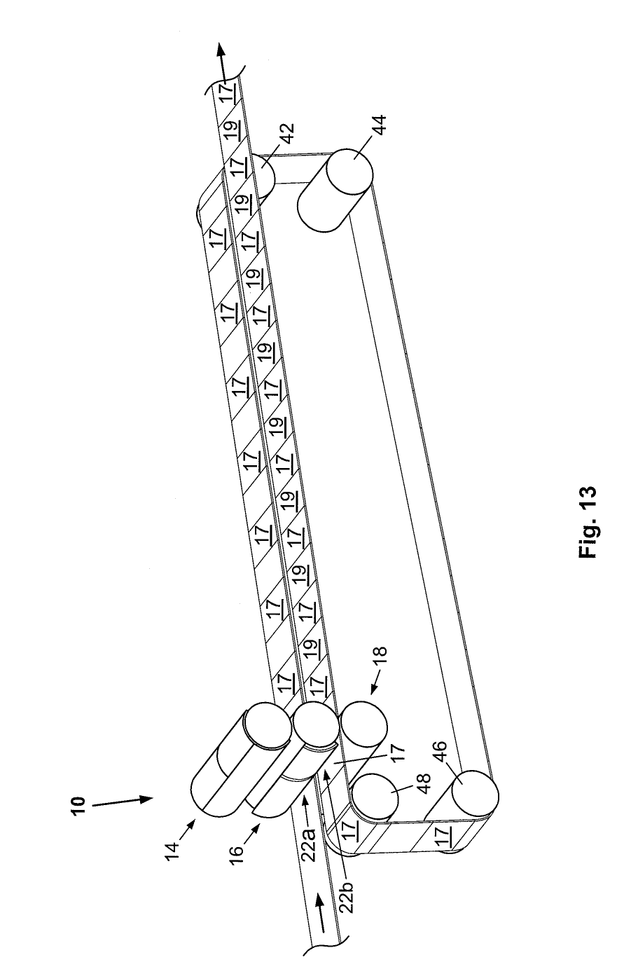

The virtual master signal may also be transmitted to respective controllers for motors driving an unwinding unit upstream of printing unit 10, any of rollers 42, 44, 46, 48 (FIG. 13) that are driven, a rewinding unit downstream of printing unit 10 and/or nip rollers that may be located upstream and downstream of printing unit 10 and assist in passing web through printing unit 10.

Plate cylinder 14 is preferably geared to ink and dampening fluid train 12, such that motor 60 also drives the rollers of ink and dampening fluid train 12. In other embodiments, plate cylinder 14 may possibly be geared to impression cylinder 18 and impression cylinder 18 may also be driven by motor 60. In such a case, gearing may be employed to allow plate cylinder 14 and impression cylinder 18 to be driven at different velocities.

In the embodiment shown in FIG. 2, blanket 16a on blanket cylinder 16 is formed as a blanket segment on only a portion of an effective circumference of blanket cylinder 16. As used herein, the effective circumference of blanket cylinder 16 is defined by a path followed by an outer circumference of blanket 16a during rotation of blanket cylinder 16. Blanket 16 has a circumferential length that is at least as long the cutoff length of the images on printing plate 14a and a width that is at least as wide as both of the images on printing plate 14a.

In other embodiments, the images on printing plate 14a may not be identical, but instead may be different. Also, in other embodiments, more than two images may be included side by side on printing plate 14a, for example printing plate 14a may include three image sections side-by-side and printing unit 10 may print on a web that passes through printing unit 10 in three different passes.

FIGS. 3 to 12 show sequential perspective views illustrating one revolution of blanket cylinder 16 during operation of printing unit 10. Printing plate 14a includes two image sections 14b, 14c side-by-side and printing blanket 16a includes two blanket sections 16b, 16c side-by-side on plate cylinder 16 that receive images 17, 19 from image sections 14b, 14c, respectively. Blanket sections 16b, 16c are each on one axial section, in this case approximately one axial half of blanket cylinder 16. Blanket 16a may be segmented to separate blanket sections 16b, 16c from each other; however, it should be noted that blanket sections 16b, 16c do not necessarily have to be distinct, divided sections of blanket 16a. As cylinders 14, 16 rotate, blanket sections 16b, 16c contact image sections 14b, 14c and due to ink and dampening solution applied to plate 14a, blanket sections 16b, 16c receive images 17, 19 from image sections 14b, 14c, respectively. Blanket cylinder 16 then rotates further and prints images 17, 19 on blanket sections 16b, 16c on two different longitudinal portions of web 20 that are traveling in the same direction on the same side of web 20.

Nip 22 may include a first nip 22a formed by blanket section 16b and one axial half of impression cylinder 18 and a second nip 22b formed by blanket section 16c and the other axial half of impression cylinder 18. Web 20, in the first pass through printing unit 10, passes through nip 22a. Before entering into nip 22a, the side of web 20 being printed by blanket section 16b at first nip 22a is unprinted. The opposite side of web 20, facing impression cylinder 18, may be unprinted or may have been previously printed. As blanket section 16b prints one image 17 on a first longitudinal portion of web 20, blanket section 16c prints one image 19 on a second longitudinal portion of web 20 that previously passed through nip 22a and was printed with images 17. At the same time, a third longitudinal portion of web 20 between the first and second longitudinal portions is being guided by rollers 42, 44, 46, 48 (See FIG. 13) to be properly aligned to pass through nip 22b. As further described below, after web 20 passes through nip 22a and images 17 are printed on web 20, spaces remain on web 20 between successive images 17 that are equal to the length of images 19 to be printed by blanket section 16c on web 20 at nip 22b in the second pass through printing unit 10. After web 20 passes through nip 22a in the first pass through printing unit 10, web 20 is redirected and passed through nip 22b in the second pass through printing unit 20 and blanket section 16c prints images 19 in the spaces between images 17 on web 20. As a result, blanket section 16b prints images 17 on web 20 as blanket section 16c prints images 19 on web 20 between images 17 previously printed on web 20 by blanket section 16b. As web 20 exits nip 22b after the second pass, web 20 includes alternating images 17, 19 printed thereon.

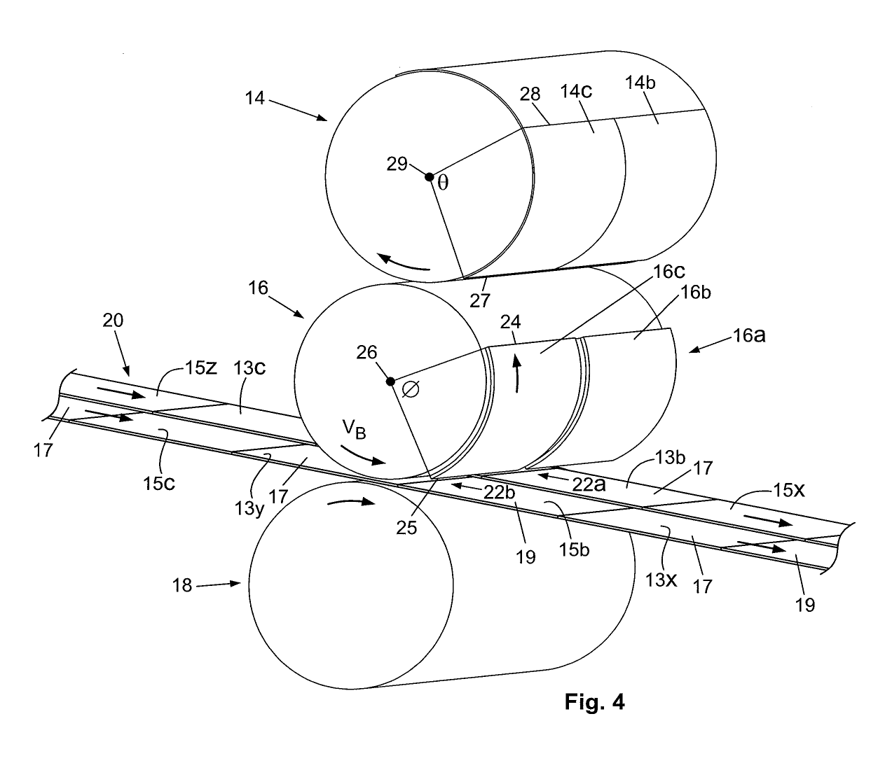

In this preferred embodiment, web 20 has a set constant surface velocity that is equal to a constant circumferential velocity of impression cylinder 18, while plate cylinder 14 has a set constant circumferential velocity that is greater than the surface velocity of web 20. These set velocities of web 20 and plate cylinder 14 may be changed by the press operator. For example, the press operator could set the speed at 200 feet per minute, and change it to 2500 feet per minute during a print job or between one print job and another print job. The difference between the circumferential velocity of plate cylinder 14 and the surface velocity of web 20 is dependent on the percentage of the effective circumference of blanket cylinder 16 that is occupied by blanket 16a (i.e., as shown in FIG. 4, an angle Ø formed by a lead edge 24 of blanket 16a, a trailing edge 25 of blanket 16a and a center axis 26 of blanket cylinder 16) and/or the percentage of the effective circumference of plate cylinder 16 that is occupied by plate 14a (i.e., as shown in FIG. 4, an angle θ formed by a lead edge 27 of image sections 14b, 14c, a trailing edge 28 of image sections 14b, 14c and a center axis 29 of plate cylinder 14). The circumferential velocity of blanket 16a is varied through each revolution of blanket cylinder 16. As discussed above with respect to FIG. 2, the variable velocity profile of blanket cylinder 16 is preferably achieved using a servomotor. However, in other embodiments the variable velocity profile of blanket cylinder 16 may be achieved mechanically, pneumatically, hydraulically or a combination thereof using rotational position feedback and/or velocity feedback sensors. In some embodiments, the circumferential velocity of plate cylinder 14 may be equal to the surface velocity of web 20.

FIG. 3 shows blanket 16a after respective blanket sections 16b, 16c finished printing images 17, 19 on web 20 in desired web sections 13b, 15b, respectively, and is coming out of contact with web 20. In the revolution of cylinder 16 before the revolution in which images 17, 19 were printed in web sections 13b, 15b, blanket sections 16b, 16c printed images 17, 19 in respective web sections 13a, 15a, which are separated from web sections 13b, 15b by web sections 13x, 15x. Web section 15x is unprinted and is to be printed by blanket section 16c after being reoriented to enter nip 22b, while web section 13x was previously printed by blanket section 16b and reoriented to enter nip 22b. In the position shown in FIG. 3, blanket 16a has a circumferential velocity equal to the surface velocity of web 20. After blanket 16a is no longer in contact with web 20, blanket cylinder 16 is accelerated in order to begin phasing blanket cylinder 16 so as to match lead edge 24 of blanket 16a to lead edge 27 of image sections 14b, 14c. In the position shown in FIG. 4, blanket cylinder 16 is being accelerated in this manner.

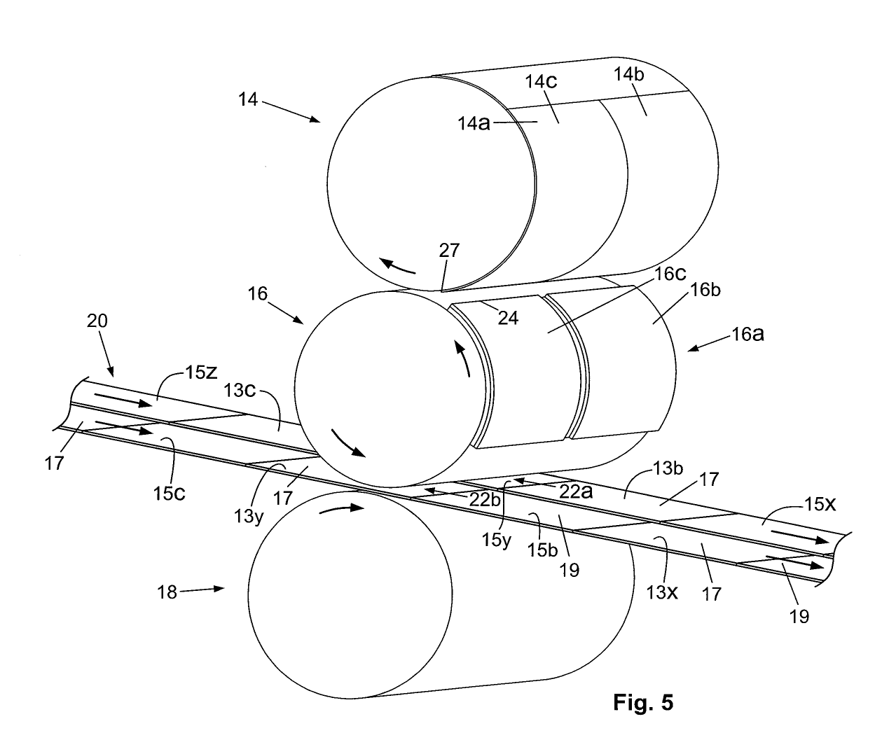

FIG. 5 shows blanket cylinder 16 before blanket 16a comes into contact with plate 14a. In this rotational position, blanket cylinder 16 is being decelerated in order to synchronize the circumferential velocity of blanket 16a to the circumferential velocity of plate 14a as lead edge 24 of blanket 16a contacts lead edge 27 of image sections 14b.

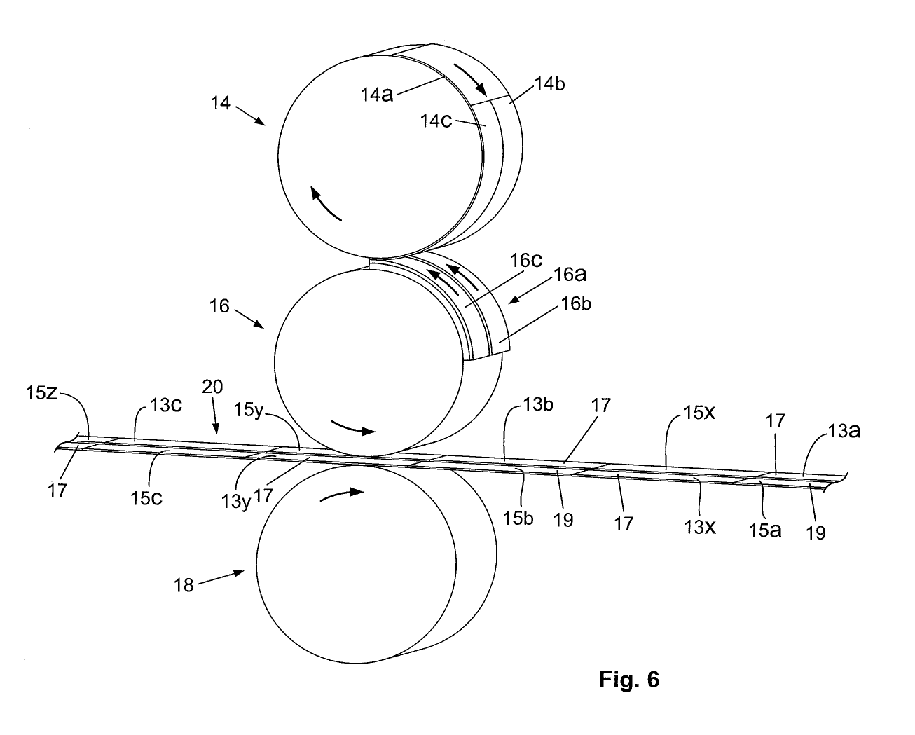

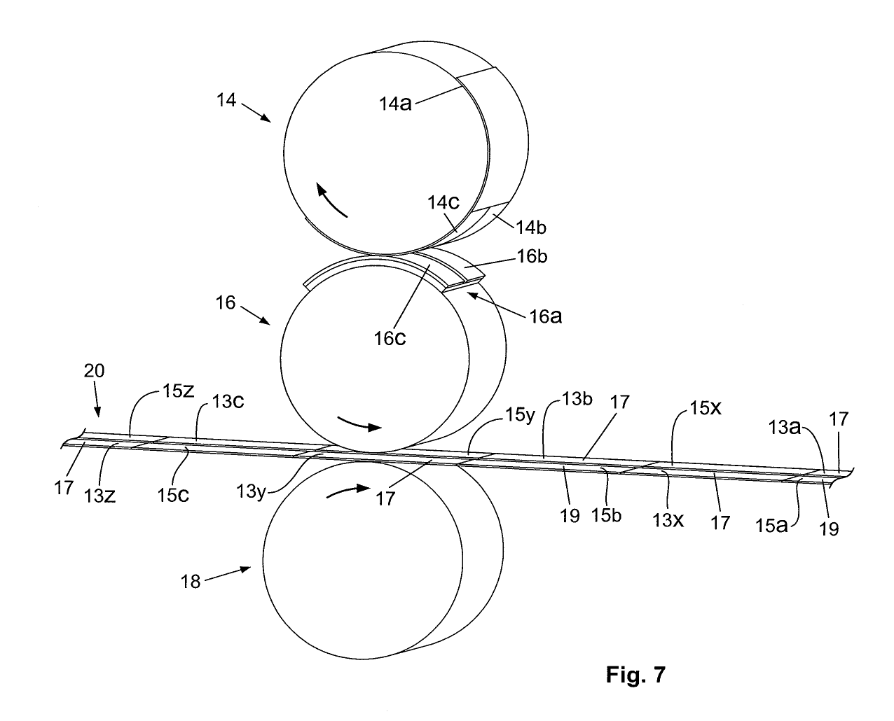

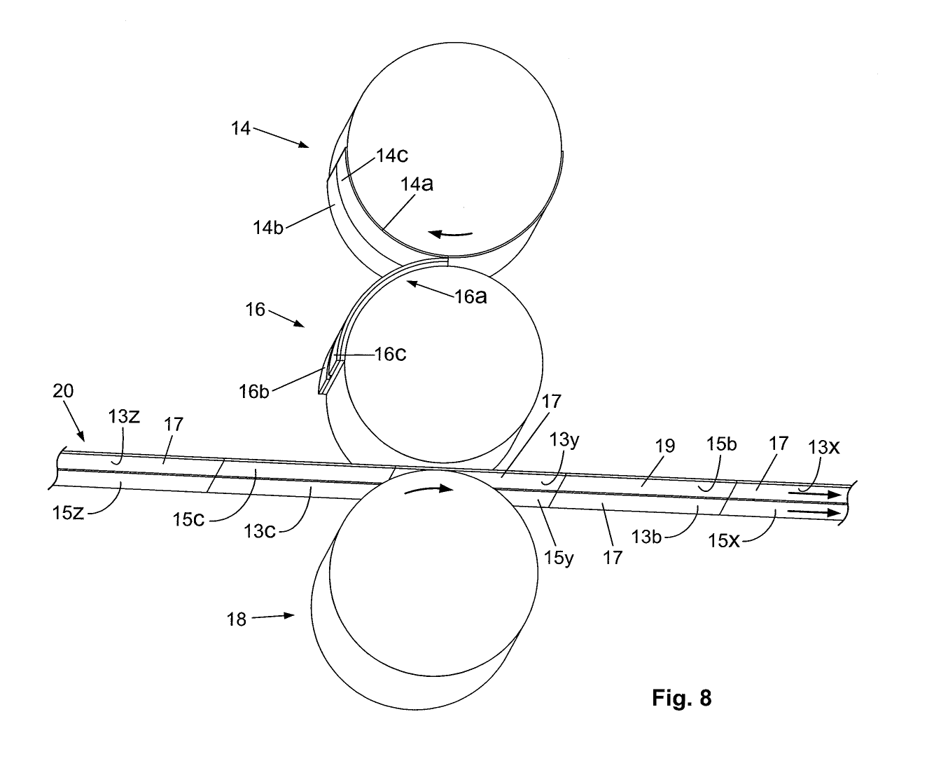

FIG. 6 shows blanket 16a contacting plate 14a. Images 17, 19 are being transferred to blanket 16a and the circumferential velocity of blanket 16a is equal to the circumferential velocity of plate 14a. In the positions shown in FIGS. 7 and 8, blanket 16a continues to travel at a constant circumferential velocity equal to the circumferential velocity of plate 14a as blanket sections 16b, 16c receive images 17, 19 from image sections 14b, 14c.

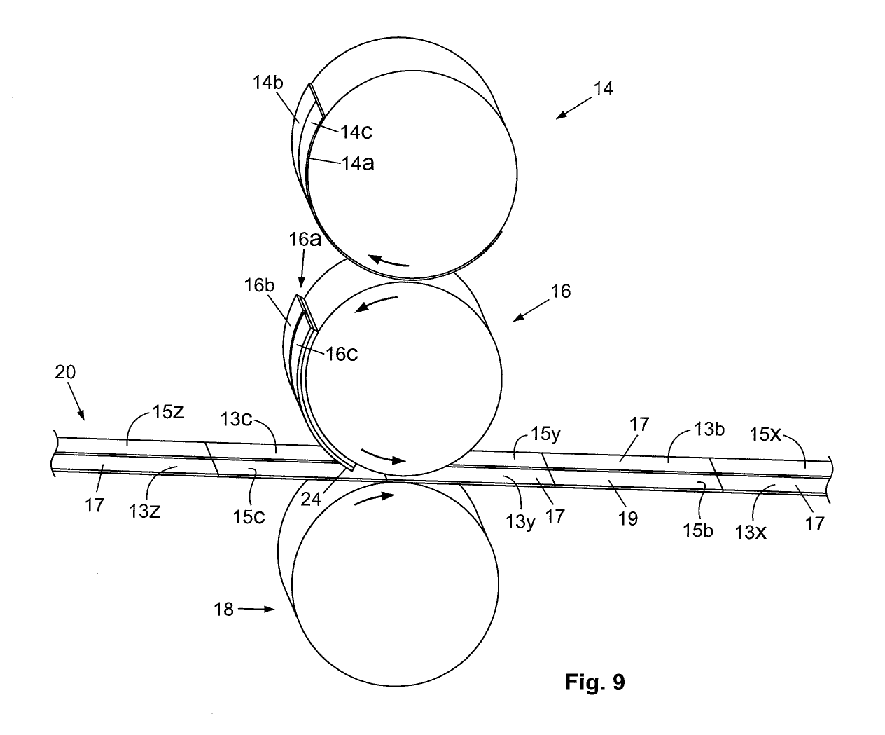

After blanket 16a is rotated out of contact with plate 14a, blanket cylinder 16 is again accelerated in order to begin properly phasing blanket 16a so lead edge 24 of blanket 16a is aligned to contact web 20 at the appropriate position. Blanket cylinder 16 is then again decelerated in order to synchronize the circumferential velocity of blanket 16a to the surface velocity of web 20 as lead edge 24 of blanket 16a contacts web 20. In the position shown in FIG. 9, blanket cylinder 16 is being decelerated in this manner.

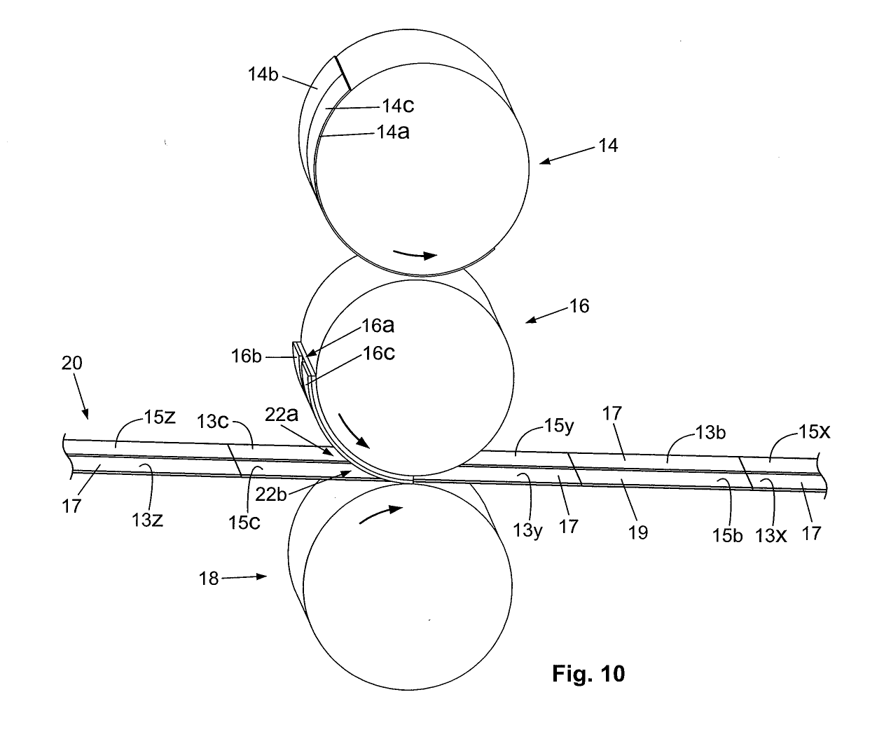

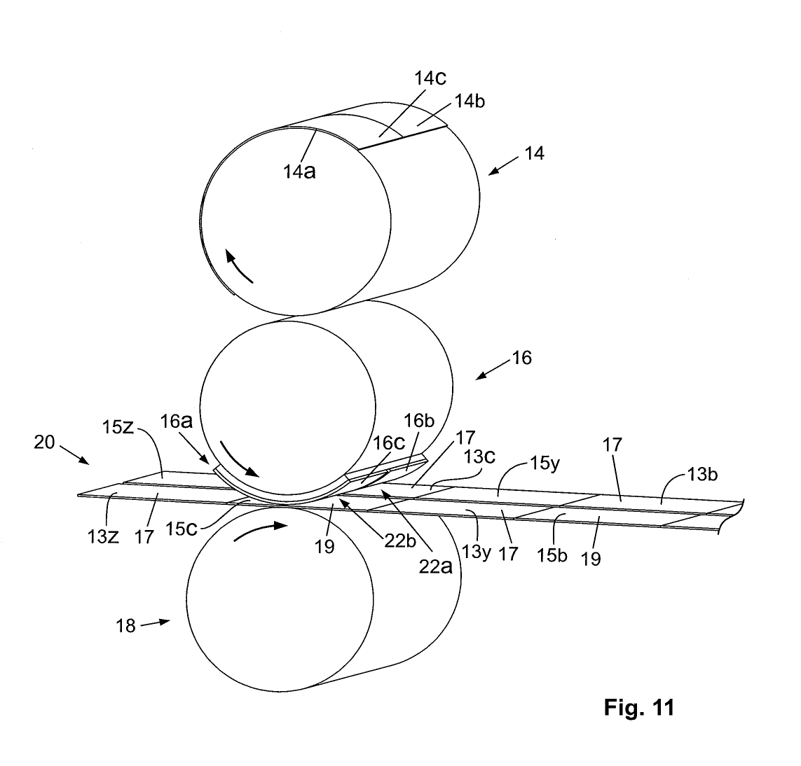

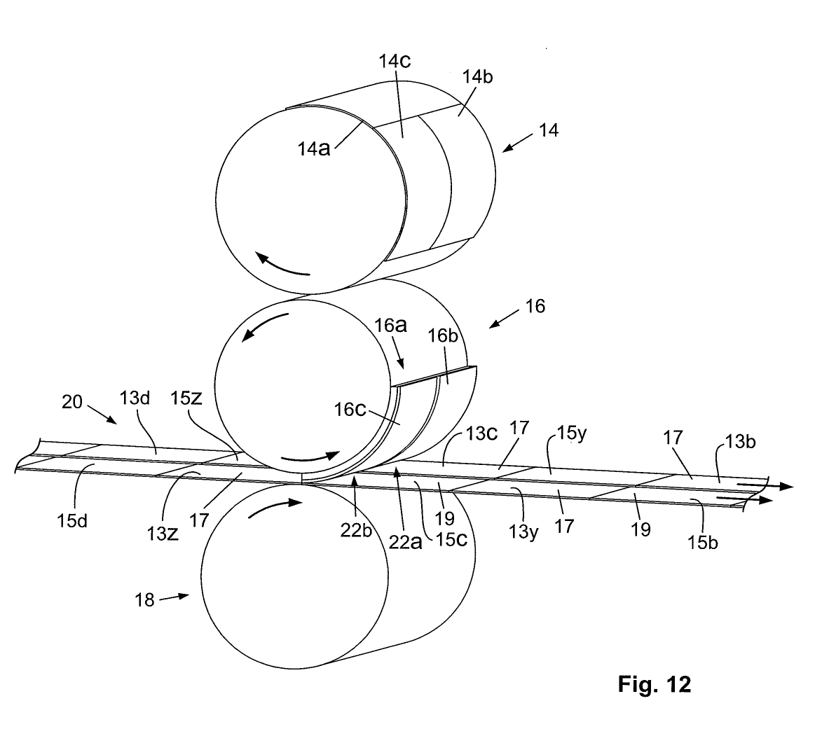

FIG. 10 shows blanket 16a beginning to print images 17, 19 on web 20 in desired web sections 13c, 15c, respectively. Web sections 13c, 15c are separated from web sections 13b, 15b printed in the previous revolution of blanket cylinder 16 by web sections 13y, 15y. Web section 15y is unprinted and is to be printed by blanket section 16c after being reoriented to enter nip 22b, while web section 13y was previously printed by with image 17 by blanket section 16b at nip 22a in a first pass through printing unit 10 and then reoriented to enter nip 22b. In the position shown in FIG. 10, blanket cylinder 16 is being rotated so the circumferential velocity of blanket 16a equals the surface velocity of web 20. Blanket cylinder 16 continues to rotate at this velocity as blanket sections 16b, 16c print images 17, 19 in web sections 13c, 15c. FIG. 11 shows blanket sections 16b, 16c in the process of printing images 17, 19 in web sections 13c, 15c. FIG. 12 shows blanket 16a in the same rotational position as in FIG. 3, after respective blanket sections 16b, 16c have finished printing images 17, 19 on web 20 in desired web sections 13c, 15c, respectively, and is coming out of contact with web 20. In the next revolution of blanket cylinder 16, web sections 13z, 15z pass through respective nips 22a, 22b without contacting blanket 16a and then blanket sections 16b, 16c print images 17, 19 in respective web sections 13d, 15d in the same manner as shown in FIGS. 3 to 12.

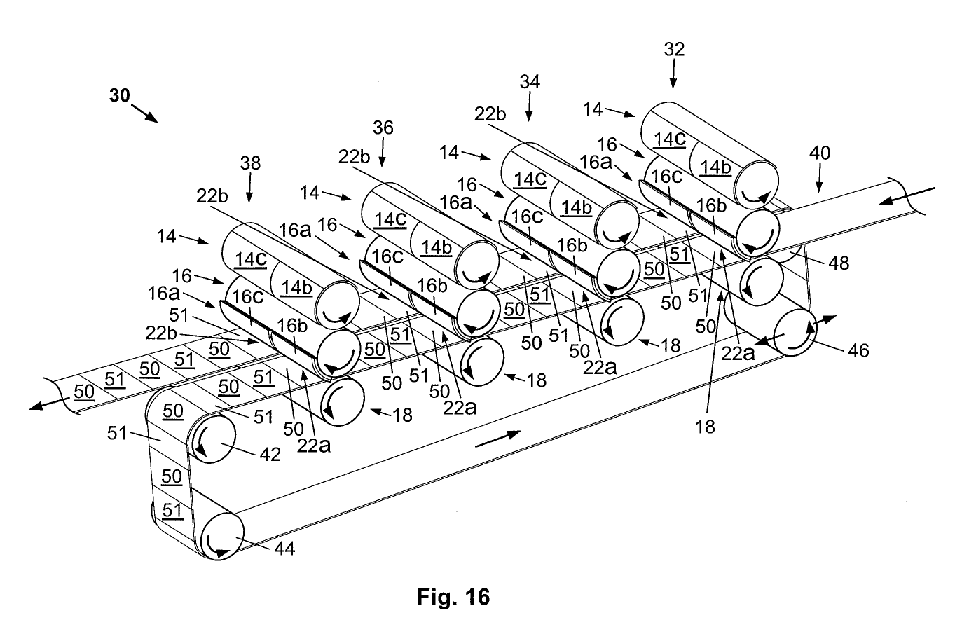

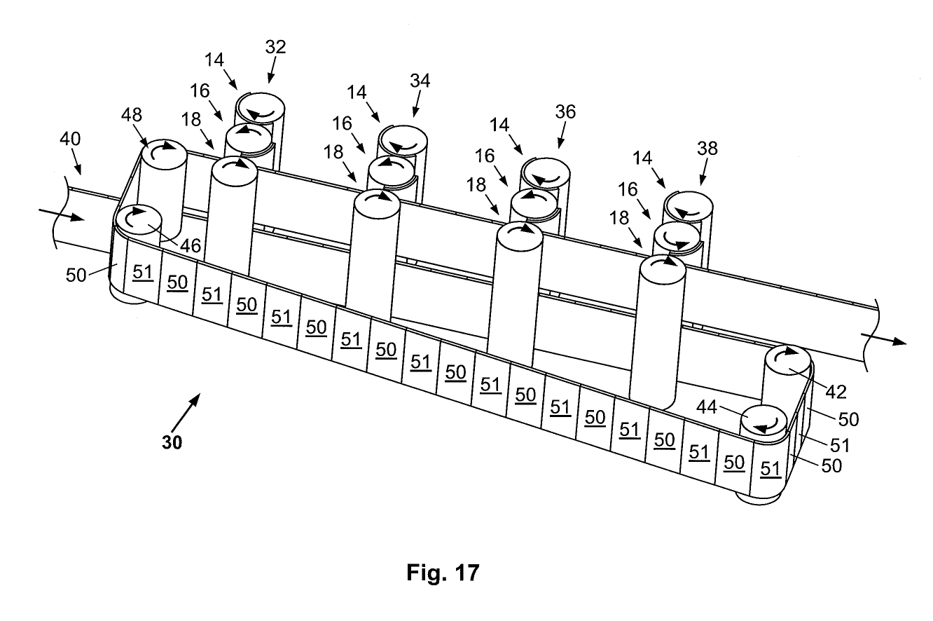

FIG. 13 shows a perspective view of printing unit 10 along with rollers 42, 44, 46, 48 for redirecting web 20 between a first pass through nip 22a of printing unit 10 and a second pass through nip 22b of printing unit 10. The arrangement and operation of rollers 42, 44, 46, 48 is further described below with respect to FIGS. 16 and 17.

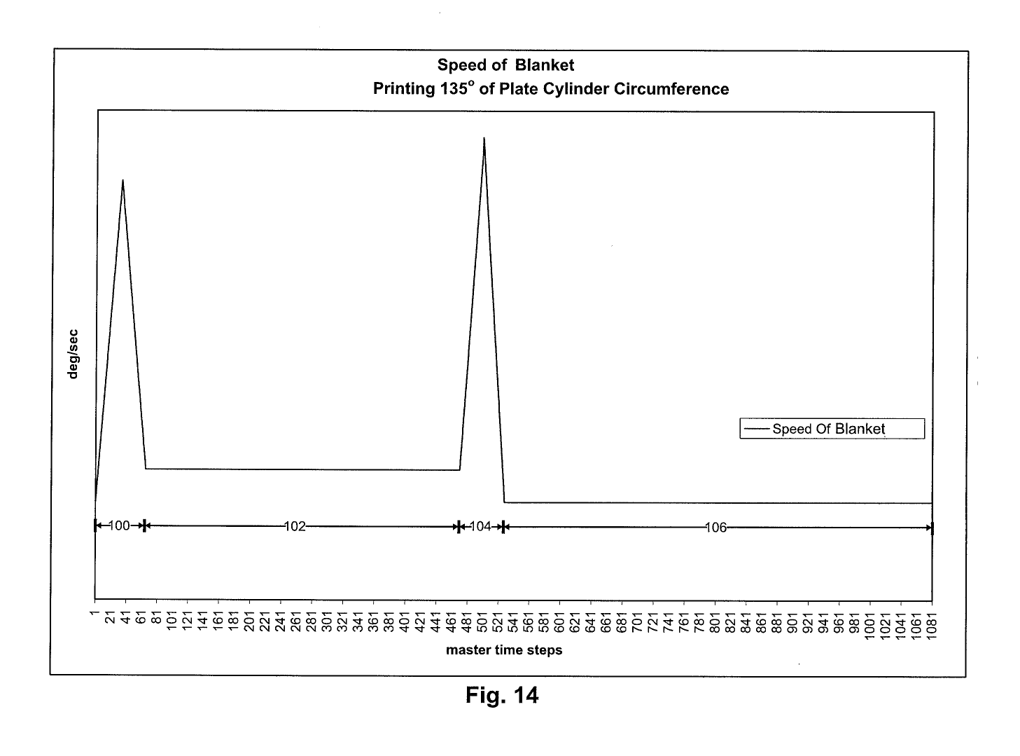

FIG. 14 shows a graph illustrating an exemplary embodiment of how the velocity of blanket cylinder 16 may be varied during each revolution to print images in the manner described in FIGS. 3 to 12. All references numbers used to describe the graph of FIG. 14 are the same as those used to describe FIGS. 3 to 12. The vertical axis of the graph is the speed of the blanket cylinder is degrees per second. The horizontal axis is the master time steps of the virtual master signal over a 0 through 360 degree rotation of the blanket cylinder. The embodiment is based on plate 14a including image sections 14b, 14c that occupy 135 degrees of the circumference of plate cylinder 14 (i.e., referring to FIG. 4, θ equals 135 degrees); however, image sections 14b, 14c may occupy between 90 and 180 degrees of the circumference of plate cylinder 14 based on the desired cutoff length. In the embodiment shown in the graph of FIG. 14, for each three master time steps, blanket cylinder 16 rotates an average of one degree, so in each revolution of blanket cylinder 16, blanket cylinder 16 moves 1080 angular steps. At the point of zero degrees of revolution of blanket cylinder 16, the master driver is at one time step and at the point of 360 degree of revolution of blanket cylinder 16, the master driver is at 1081 times steps. In a first phase 100, which corresponds to the sequence shown beginning at FIG. 3 and up to FIG. 6, plate cylinder 16 is accelerated after completing printing on web 20 and then decelerated so lead edge 24 of blanket 16a is in the proper position to receive images 17, 19 from printing plate 14a and so the circumferential velocity of blanket 16a equals the circumferential velocity of plate 14a when blanket 16a contacts plate 14a. Then, in a second phase 102, which corresponds to the sequence shown beginning at FIG. 6 and up to FIG. 8, blanket cylinder 16 is rotated at a constant velocity so the circumferential velocity of blanket 16a equals the circumferential velocity of plate 14a as plate 14a transfers images 17, 19 to blanket 16a. After blanket 16a receives images 17, 19, blanket cylinder 16 is again accelerated and decelerated in a phase 104, which corresponds to the sequence shown beginning at FIG. 8 and up to FIG. 10, so the lead edge of blanket 16a is in the proper position to print images 17, 19 received from printing plate 14a onto web 20 and so the circumferential velocity of blanket 16a equals the surface velocity of web 20 when blanket 16a contacts web 20. Next, in a phase 106, which corresponds to the sequence shown beginning at FIG. 10 and up to FIG. 12, blanket cylinder 16 is rotated at a constant velocity so the circumferential velocity of blanket 16a equals the surface velocity of web 20 as blanket 16a transfers images 17, 19 to web 20.

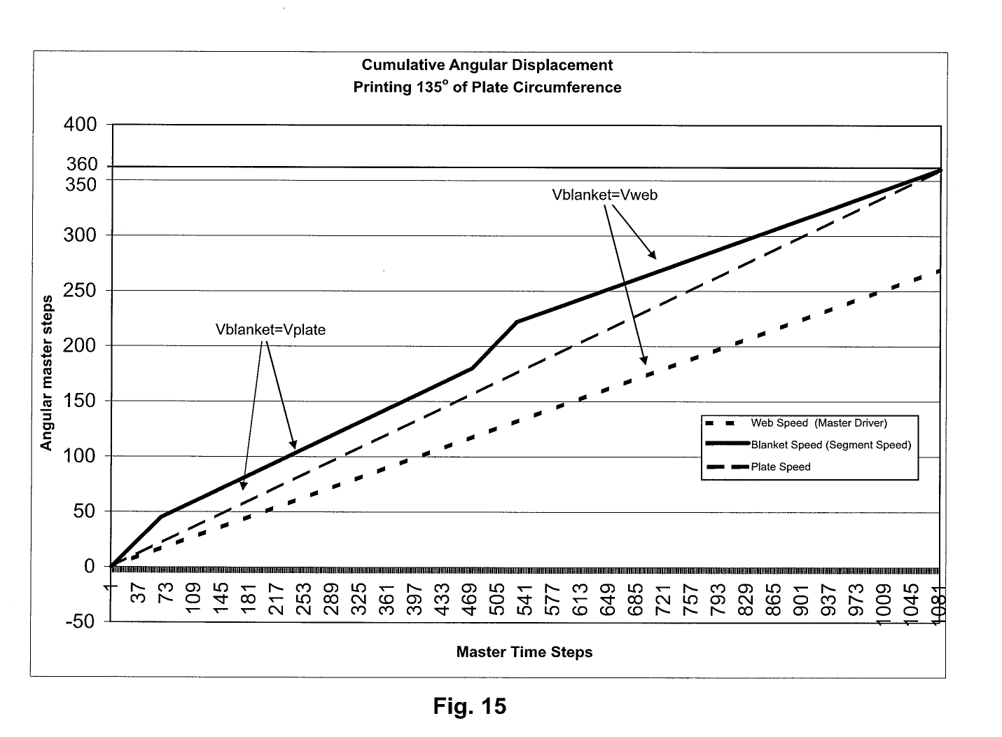

FIG. 15 shows a graph corresponding to the exemplary embodiment shown in FIG. 14 illustrating a relationship between angular master steps of the virtual master signal and master time steps of plate cylinder 14, blanket cylinder 16 and a master driver. The vertical axis of the graph is the angular master steps of the virtual master software. The horizontal axis is the master time steps of the virtual master signal over a 0 through 360 degree rotation of both plate cylinder 14 and blanket cylinder 16. Plate 14a and blanket 16a each rotate 360 degrees on respective cylinders 14, 16 and move 360 angular master steps during 1080 master time steps. As a result, plate 14a and blanket 16a rotate 360 degrees during 360 angular master steps and 1080 master time steps so plate 14a and blanket 16a are synchronized to contact each other in the same manner during each revolution. The master driver, the speed of web 20 driven by impression cylinders 18, unwinding/rewinding units and any of rollers 42, 44, 46, 48 that are driven, moves 270 angular master steps during 1080 master time steps. The value of 1080 master time steps used herein in merely exemplary and can be set based on how the velocity profile is created.

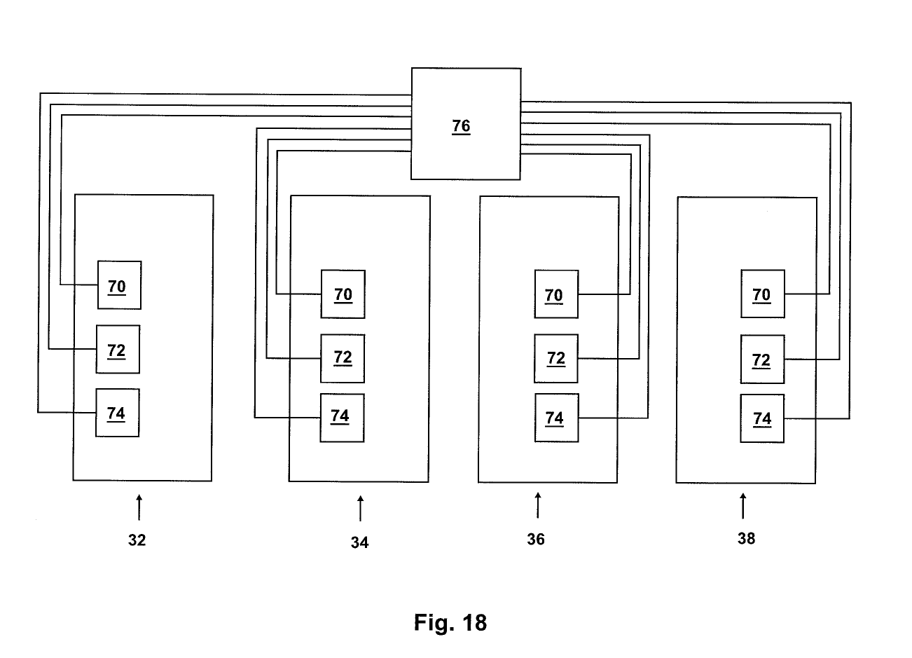

FIGS. 16 and 17 show perspective views of a variable cutoff four color printing press 30 according to an embodiment of the present invention. Printing press 30 includes four printing units 32, 34, 36, 38 each printing in a different color on a web 40. Each printing unit 32, 34, 36, 38 includes plate cylinder 14, blanket cylinder 16 and impression cylinder 18 described above with respect to FIGS. 2 to 13 and operates in the same manner as described in FIGS. 3 to 12. In one preferred embodiment, as shown schematically in FIG. 18, all of printing units 32, 34, 36, 38 are controlled using virtual master software in controller 76. In this embodiment, each printing unit 32, 34, 36, 38 includes motors 60, 62, 64 (FIG. 2) driving respective cylinders 14, 16, 18, such that printing press 30 includes four of each of motors 60, 62, 64 (FIG. 2), four of each of controllers 70, 72, 74 and four of each of encoders 80, 82, 84 (FIG. 2), with each of the twelve controllers receiving the virtual master signal from controller 76 and synchronizing the associated motors for cylinders 14, 16, 18 using virtual master software included in controller 76. The virtual master signal may also be transmitted to respective controllers for motors driving any of rollers 42, 44, 46, 48 that are driven, an unwinding unit upstream of printing unit 32, a rewinding unit downstream of printing unit 38 and/or nip rollers that may be located upstream of printing unit 32 and downstream of printing unit 38 that assist in passing web through printing units 32, 34, 36, 38.

In one alternative embodiment, instead of each printing unit 32, 34, 36, 38 including three controllers 70, 72, 74, each printing unit 32, 34, 36, 38 may include one controller receiving feedback from all encoders 80, 82, 84 of the respective printing unit 32, 34, 36, 38, with the controller of each printing unit 32, 34, 36, 38 communicating with controller 76 to determine the virtual master signal and controlling the respective motors 60, 62, 64 accordingly. In another alternative embodiment, controllers 70, 72, 76 may be omitted and the feedback from each of the twelve encoders 80, 82, 84 may be directed to controller 76, such that controller 76 receives the signals from encoders 80, 82, 84 and controls the respective motors 60, 62, 64 accordingly.

In operation of printing press 30, web 40 is unwound from the unwinding unit and passes through nip 22a of printing unit 32. During each revolution of plate cylinder 14 and blanket cylinder 16 of printing unit 32, printing plate 14a transfers an image on first image section 14b to blanket section 16b of blanket 16a and blanket cylinder 16 prints the image on one of web sections 50. Because each of the images printed by blanket section 16b of printing unit 32 on web 40 have a length that is less than the effective circumferential length of cylinders 14, 16, each image printed in web sections 50 are spaced from the images in the previous and subsequent web sections 50, leaving unprinted spaces in web sections 51 on web 40.

After one image is printed on web 40 by blanket section 16b of printing unit 32, blanket sections 16b of printing units 34, 36, 38 print on web 40 is the same manner on top of the one image, such that after blanket section 16b of printing unit 38 prints on web 40, a four color image is printed on web 40. After web 40 has passed through nips 22a of printing units 32, 34, 36, 38 in a first pass and each of printing units 32, 34, 36, 38 has printed on web 40 with the respective blanket section 16b, web 40 is redirected by rollers 42, 44, 46, 48 so that web 40 reenters printing unit 32. One or more of rollers 42, 44, 46, 48 may be driven by one or more motors. In a second pass through printing units 32, 34, 36, 38, web passes through nips 22b of printing units 32, 34, 36, 38 and blanket sections 16c of printing units 32, 34, 36, 38 then successively print different colored images in web sections 51 to form four color images in each web section 51.

After web 40 has passed through printing units 32, 34, 36, 38 twice, in the first pass through nips 22a of printing units 32, 34, 36, 38 and in the second pass through nips 22b of printing units 32, 34, 36, 38, web 40 includes images in web sections 50 and web sections 51. Images in web section 50 may be identical to or different from images in web sections 51. After web 40 has passed through nips 22b, web 40 may be rewound by a rewind unit or pass to post-press equipment, such as a folder, for further processing. Also, a dryer and chill roller arrangement may be provided downstream of nip 22b to dry web 40 before web is either further processed or rewound.

Axes of rollers 42, 44, 46, 48 are adjustably arranged so that web 40 is shifted laterally with respect to the longitudinal portion of web 40 passing through nips 22a before web 40 enters nip 22b of printing unit 32. Rollers 42, 44, 46, 48 may be moved angularly between print jobs based on the width of web 40 so that printing press 30 can print webs of different widths. Distances between rollers 42, 44, 46, 48 may also be adjusted to register images printed by blanket sections 16b with images printed by blanket sections 16c. As shown in FIGS. 15 and 16, axes of rollers 42, 48 are parallel to the axes of cylinders 14, 16, 18 of printing units 32, 34, 36, 38. Also, axes of rollers 44, 46 are angled with respect to axes of cylinders 14, 16, 18 of printing units 32, 34, 36, 38 and axes of rollers 42, 48. Roll 42 is aligned with the axial half of impression cylinder 18 of printing unit 38 that cooperates with blanket section 16b and downstream of nip 22a of printing unit 38. Roll 48 is aligned with the axial half of impression cylinder 18 of printing unit 38 that cooperates with blanket section 16c upstream of nip 22b of printing unit 32. Roll 44 is positioned below roll 42 and angles web 40 towards roll 46, which is positioned below roll 48. Roll 46 directs web 40 toward roll 48.

Printing press 30 may print images of any cutoff length, within theoretical and practical limits imposed by the acceleration and deceleration of blanket cylinder 16, based on the printing length of images on printing plates 14a and the length of blanket 16a. Plates 14a may wrap entirely around plate cylinders 14 or may only occupy a portion of the circumferences of plate cylinders 14. Images may also be directly imaged on plate cylinder 14 in alternative to using printing plates 14a. Varying the cutoff of plate cylinder 14 may thus involve removing and replacing plates 14a or reimaging plate cylinder 14. In order to vary a cutoff length to be printed by printing units 32, 34, 36, 38 of printing press 30, blanket 16a may be mounted on a sleeve which is replaced during between print jobs. Each sleeve may have the same effective circumference, but may include blankets of varying printing lengths to vary the cutoff between print jobs. Alternatively, each blanket may simply be a strip of material of a desired length that is applied to the surface of a cylinder body. The strip of material may be removably secured to the cylinder body by adhesive or by an adjustable locking mechanism. Blankets 16a may also have a length that is longer than the cutoff length of images received from plate cylinder 14a and printed on web 40, in which case a cutoff change within the length of blankets 16a would not necessarily require blankets 16a to be changed. In such an instance, blankets 16a may need to be washed during the cutoff change and the velocity profile of blanket cylinder 16 may be accordingly adjusted.

In another embodiment of the present invention, printing press 30 may be a perfecting printing press, with printing units 32, 34, 36, 38 each including two plate cylinders and two blanket cylinders and printing on both side of web 40. In a perfecting printing press, in each printing unit, blanket sections 16b, 16c on opposite sides of web 40 would operate in synchronization to contact web 40 at the same time.

Although printing press 30 has four printing units, embodiments of the present invention may include one printing unit or as many as ten or more printing units

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A variable cutoff printing press comprising:
a first cylinder printing on a web at a first longitudinal portion of the web and a second longitudinal portion of the web at the same time, the second longitudinal portion being downstream of the first longitudinal portion at least a distance equal to an effective circumference of the first cylinder; and
a second cylinder forming at least one nip with the first cylinder, the first and second longitudinal portions of the web passing through the at least one nip.

2. The printing press recited in claim 1 further comprising a plate cylinder, the first cylinder being a blanket cylinder, the plate cylinder transferring images to the blanket cylinder.

3. The printing press recited in claim 1 further comprising a plurality of rollers orienting a third longitudinal portion of the web, the third longitudinal portion being between the first longitudinal portion and the second longitudinal portion.

4. The printing press recited in claim 1 wherein the first cylinder includes a blanket forming a portion of the effective circumference of the first cylinder, the blanket including a first axial section printing on the first longitudinal portion of the web and a second axial section printing on the second longitudinal portion of the web.

5. The printing press recited in claim 4 wherein the first axial section prints images on the web with spaces in between each image and the second axial section prints images in the spaces.

6. The printing press recited in claim 4 further comprising a plurality of rollers, the plurality of rollers being positioned downstream of the first axial section with respect to the web and upstream of the second axial section with respect to the web, the plurality of rollers orienting the web after printing by the first axial section so the web is aligned for printing by the second axial section.

7. The printing press recited in claim 6 wherein an axis of at least one of the rollers is angled with respect to an axis of the first cylinder.

8. The printing press recited in claim 1 further comprising a servomotor driving the first cylinder and a controller controlling the servomotor.

9. The printing press recited in claim 8 further comprising an encoder or resolver detecting an angular position of the first cylinder, the controller receiving the detected angular position and driving the servomotor according to the detected angular position and a virtual master signal.

10. The printing press recited in claim 9 wherein the encoder or resolver detects the angular position of the first cylinder by detecting a position of drive shaft of the servomotor.

11. A variable cutoff printing press comprising:
a blanket cylinder printing on a web and including a first blanket section and a second blanket section side-by-side,
an additional cylinder forming at least one nip with the first cylinder, the web being printed by the first blanket section in a first pass of the web through the at least one nip, the web being printed by the second blanket section in a second pass of the web through the at least one nip.

12. The printing press recited in claim 11 further comprising a plate cylinder providing a first image to the first blanket section and a second image to the second blanket section.

13. The printing press recited in claim 12 wherein during the first pass the first blanket section successively prints the first image on the web and during the second pass the second blanket section successively prints the second image on the web such that after the second pass the first image and the second image are alternately printed on the web.

14. The printing press recited in claim 12 wherein the first image and the second image are identical.

15. The printing press recited in claim 11 further comprising a plurality of rollers, the plurality of rollers guiding the web between the first pass and the second pass.

16. The printing press recited in claim 11 further comprising a servomotor driving the first cylinder and a controller controlling the servomotor.

17. The printing press recited in claim 16 further comprising an encoder or resolver detecting an angular position of the first cylinder, the controller receiving the detected angular position and driving the servomotor according to the detected angular position and the virtual master signal.

18. The printing press recited in claim 17 wherein the encoder or resolver detects the angular position of the first cylinder by detecting a position of drive shaft of the servomotor.

19. A variable cutoff printing press comprising:
a first removable blanket section rotating about a first axis; and
a second removable blanket section rotating about the first axis, the first blanket section printing a first longitudinal section of a web as the second blanket section prints a second longitudinal section of the web previously printed by the first blanket section.

20. The variable cutoff printing press recited in claim 19 further comprising a plate cylinder providing a first image to the first blanket section and a second image to the second blanket section.

21. The variable cutoff printing press recited in claim 19 wherein the first image and the second image are identical.

22. The printing press recited in claim 19 further comprising a plurality of rollers, the plurality of rollers positioned downstream of the first blanket section and upstream of the second blanket section, the plurality of rollers orienting the web after printing by the first blanket section so the web is aligned for printing by the second blanket section.

23. A method of printing a web comprising:
printing a first image on a web with a first axial section of a blanket cylinder;
guiding the web around a plurality of rollers; and
printing a second image on the web with a second axial section of the blanket cylinder adjacent to the first image.

24. A method of variable cutoff printing comprising:
printing a first print job by printing a first web twice with two different axial sections of a first blanket having a first cutoff length;
replacing the first blanket with a second blanket having a second cutoff length different from the first cutoff length; and
printing a second print job by printing a second web twice with two different axial sections of the second blanket.

25. A variable cutoff printing press comprising:
a first printing unit including a first plate cylinder and a first blanket cylinder, the first plate cylinder transferring side-by-side images to the first blanket cylinder, the first blanket cylinder printing one of the images on a first longitudinal portion of a web and another of the images on a second longitudinal portion of the web;
a second printing unit downstream of the first printing unit, the second printing unit including a second plate cylinder and a second blanket cylinder, the second plate cylinder transferring side-by-side images to the second blanket cylinder, the second blanket cylinder printing one of the images on the first longitudinal portion of the web and another of the images on the second longitudinal portion of the web;
a third printing unit downstream of the second printing unit, the third printing unit including a third plate cylinder and a third blanket cylinder, the third plate cylinder transferring side-by-side images to the third blanket cylinder, the third blanket cylinder printing one of the images on the first longitudinal portion of the web and another of the images on the second longitudinal portion of the web; and
a fourth printing unit downstream of the third printing unit, the fourth printing unit including a fourth plate cylinder and a fourth blanket cylinder, the fourth plate cylinder transferring side-by-side images to the fourth blanket cylinder, the fourth blanket cylinder printing one of the images on the first longitudinal portion of the web and another of the images on the second longitudinal portion of the web.

26. The printing press recited in claim 25 further comprising a plurality of rollers orienting a third longitudinal portion of the web, the third longitudinal portion being between the first longitudinal portion and the second longitudinal portion.

27. The printing press recited in claim 25 further comprising a first servomotor driving the first blanket cylinder according to a virtual master signal, a second servomotor driving the second blanket cylinder according to the virtual master signal, a third servomotor driving the third blanket cylinder according to the virtual master signal and a fourth servomotor driving the fourth blanket cylinder according to the virtual master signal.

28. The printing press recited in claim 27 further comprising at least one controller controlling the first servomotor, the second servomotor, the third servomotor and the fourth servomotor.

29. The printing press recited in claim 28 further comprising a first encoder or resolver detecting an angular position of the first blanket cylinder, a second encoder or resolver detecting an angular position of the second blanket cylinder, a third encoder or resolver detecting an angular position of the third blanket cylinder and a fourth encoder or resolver detecting an angular position of the fourth blanket cylinder, the at least one controller receiving the detected angular positions of the first, second, third and fourth blanket cylinders and driving the first, second, third and fourth servomotors according to the respective detected angular positions and the virtual master signal.

30. The printing press recited in claim 29 wherein the first, second, third and fourth encoders or resolvers detect the angular positions of the first, second, third and fourth blanket cylinders by detecting a position of drive shafts of the first, second, third and fourth servomotors.
